(19) United States
(12) Patent Application Publication
(10) Pub. No.: US 2026/0260795 A1
(43) Pub. Date: Sep. 3, 2026

(54) CORE PIECE, REACTOR, CONVERTER AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tsukasa KOGA, Mie (JP); Toru SHIMIZU, Mie (JP); Shinichiro YAMAMOTO, Mie (JP)

(21) Appl. No.: 19/165,140

(22) PCT Filed: Mar. 1, 2024
(86) PCT No.: PCT/JP2024/007760

§ 371 Date: Sep. 15, 2025

(30) Foreign Application Priority Data
Mar. 16, 2023 (JP) 2023-042395

(51) Int. Cl. H01F 1/28; B60L 15/00; H01F 27/255; H01F 41/02

(52) U.S. Cl. CPC H01F 1/28; H01F 27/255; H01F 41/0246; B60L 15/007; B60L 2210/10; B60L 2210/40

(57) ABSTRACT

Disclosed is a core piece that constitutes a part of a magnetic core, and is configured from a molded body of a composite material in which a soft magnetic powder is dispersed in a resin. This core piece comprises a first core part and a second core part. The first core part and the second core part extend in directions that are orthogonal to each other. The soft magnetic powder is oriented in different directions in the first core part and the second core part, and in at least one of the first core part and the second core part, the soft magnetic powder is oriented in a direction in which the at least one core part extends.

### TECHNICAL FIELD

The present disclosure relates to a core piece, a reactor, a converter, and a power conversion device.

The present application claims priority based on JP 2023-042395 A filed on Mar. 16, 2023, and incorporates all the contents described in the Japanese application.

### BACKGROUND

A reactor is a component of a converter mounted in vehicles such as hybrid vehicles. The reactors described in Patent Document 1 and Patent Document 2 include a coil and a magnetic core. The coil includes a winding portion formed by winding a wire. The number of winding portions may be one or more.

The magnetic core is formed by combining a plurality of core pieces. Each core piece is constituted, for example, by a compacted powder molded body formed by compression-molding soft magnetic powder or a molded body of a composite material in which soft magnetic powder is dispersed in resin.

### PRIOR ART DOCUMENT

### Patent Document

Patent Document 1: JP 2017-135334 A
Patent Document 2: JP 2016-201509 A

### SUMMARY OF THE INVENTION

A core piece according to the present disclosure is a core piece constituting a portion of a magnetic core, wherein the core piece is constituted by a molded body of a composite material in which soft magnetic powder is dispersed in resin, the core piece includes a first core portion and a second core portion, the first core portion and the second core portion extend in directions orthogonal to each other, the soft magnetic powder is oriented in different directions in the first core portion and the second core portion, and in at least one core portion of the first core portion and the second core portion, the soft magnetic powder is oriented in a direction in which the at least one core portion extends.

### BRIEF DESCRIPTION OF THE DRAWINGS

FIG. 1 is a schematic perspective view showing a reactor according to an embodiment.

FIG. 2 is a schematic plan view showing the reactor according to the embodiment.

FIG. 3 is a schematic diagram showing the orientation state of soft magnetic powder in an anisotropic core portion.

FIG. 4 is a schematic diagram showing the orientation state of soft magnetic powder in an isotropic core portion.

FIG. 5 is a schematic diagram illustrating the degree of orientation of soft magnetic powder.

FIG. 6 is a schematic configuration diagram showing an example of a mold for molding a first core piece.

FIG. 7 is a schematic configuration diagram showing another example of a mold for molding the first core piece.

FIG. 8 is a contour diagram showing the distribution of magnetic flux density when an end core portion of the first core piece is anisotropic.

FIG. 9 is a contour diagram showing the distribution of magnetic flux density when the first core piece is isotropic.

FIG. 10 is a graph showing the inductance when the end core portion of the first core piece is anisotropic.

FIG. 11 is a contour diagram showing the distribution of Joule loss density when a middle core portion of the first core piece is anisotropic.

FIG. 12 is a contour diagram showing the distribution of Joule loss density when the first core piece is isotropic.

FIG. 13 is a graph showing the inductance when the middle core portion of the first core piece is anisotropic.

FIG. 14 is a contour diagram showing the distribution of magnetic flux density when a side core portion of the first core piece is anisotropic.

FIG. 15 is a graph showing the inductance when the side core portion of the first core piece is anisotropic.

FIG. 16 is a configuration diagram schematically showing a power supply system of a hybrid vehicle.

FIG. 17 is a circuit diagram showing an outline of an example of a power conversion device including a converter.

### DETAILED DESCRIPTION TO EXECUTE THE INVENTION

### Technical Problem

Compared to a compacted molding, a molded body of a composite material has lower iron loss, but also has lower relative permeability. To reduce losses generated in the magnetic core, it has been considered to form portions of the magnetic core with core pieces each made of a molded body of composite material. A core piece made of a molded body of composite material can reduce losses generated in the magnetic core. However, due to the low relative permeability of the molded body of composite material, leakage magnetic flux is likely to occur. If leakage magnetic flux from the core piece increases, coil loss may increase or the leakage magnetic flux may affect the surroundings. Therefore, there is a demand for a core piece that can reduce leakage magnetic flux.

One objective of the present disclosure is to provide a core piece capable of reducing leakage magnetic flux.

### Advantageous Effects of the Present Disclosure

The core piece according to the present disclosure can reduce leakage magnetic flux.

### Description of Embodiments of the Present Disclosure

First, embodiments of the present disclosure are listed and described.

(1) A core piece according to the present disclosure is a core piece constituting a portion of a magnetic core, wherein the core piece is constituted by a molded body of a composite material in which soft magnetic powder is dispersed in resin, the core piece includes a first core portion and a second core portion, the first core portion and the second core portion extend in directions orthogonal to each other, the soft magnetic powder is oriented in different directions in the first core portion and the second core portion, and in at least one core portion of the first core portion and the second core portion, the soft magnetic powder is oriented in a direction in which the at least one core portion extends.

The core piece according to the present disclosure can reduce leakage magnetic flux. The above core piece is partially anisotropic. In the above core piece, the soft magnetic powder is oriented in different directions in the first core portion and the second core portion. At least one core portion has a high relative permeability in the direction in which the core portion extends because the soft magnetic powder is oriented in the direction in which the core portion extends. When magnetic flux flows in the direction in which the core portion extends, leakage magnetic flux from the core portion can be reduced. According to the above core piece, it is possible to reduce coil losses caused by leakage magnetic flux or suppress the influence of leakage magnetic flux on the outside. Furthermore, since magnetic flux passes more easily in the direction in which the core portion extends, the variation in the magnetic flux linked with the coil increases, thereby increasing inductance.

(2) In the core piece according to (1) described above, in each core portion of the first core portion and the second core portion, the soft magnetic powder may be oriented in a direction in which the core portion extends.

The core piece according to (2) described above can reduce leakage magnetic flux from each core portion.

(3) In the core piece according to (1) described above, in one core portion of the first core portion and the second core portion, the soft magnetic powder may be oriented in a direction in which the one core portion extends, and in the other core portion of the first core portion and the second core portion, the soft magnetic powder may not be oriented.

The core piece according to (3) described above is easy to manufacture.

(4) A reactor according to the present disclosure is a reactor including a coil and a magnetic core, wherein the magnetic core includes a plurality of core pieces including a first core piece, and the first core piece is the core piece according to any one of (1) to (3) described above.

The reactor according to the present disclosure can reduce the leakage magnetic flux from the magnetic core. Therefore, the reactor according to the present disclosure can reduce coil losses caused by leakage magnetic flux or suppress the influence of leakage magnetic flux on the outside. Furthermore, since magnetic flux passes more easily in the direction in which the magnetic core extends, the variation in the magnetic flux linked with the coil increases, thereby increasing inductance.

(5) In the reactor according to (4) described above, the first core piece may include at least one of a middle core portion and a side core portion, and include an end core portion, the end core portion may be disposed so as to face an end surface of the coil and extend in a direction orthogonal to the axis of the coil, the middle core portion and the side core portion may each extend from the end core portion in a direction along the axis of the coil, the middle core portion may be disposed inside the coil, the side core portion may be disposed in parallel with the middle core portion so as to sandwich the coil, the end core portion may be the first core portion, and at least one of the middle core portion and the side core portion may be the second core portion.

The reactor according to (5) described above can reduce the leakage magnetic flux from the magnetic core.

(6) In the reactor according to (5) described above, the first core piece may include three core portions, namely the end core portion, the middle core portion, and the side core portion.

The above first core piece is E-shaped.

(7) In the reactor according to (5) or (6) described above, the soft magnetic powder in the end core portion may be oriented in the direction in which the end core portion extends.

The configuration according to (7) described above can reduce the leakage magnetic flux from the end core portion.

(8) In the reactor according to any one of (5) to (7) described above, the soft magnetic powder in the middle core portion may be oriented in the direction in which the middle core portion extends.

The configuration according to (8) described above can reduce leakage magnetic flux from the middle core portion.

(9) In the reactor according to any one of (5) to (8) described above, the soft magnetic powder in the side core portion may be oriented in the direction in which the side core portion extends.

The configuration according to (9) described above can reduce the leakage magnetic flux from the side core portion.

(10) A converter according to the present disclosure includes a reactor according to any one of (4) to (9) described above.

The converter according to the present disclosure can reduce losses caused by leakage magnetic flux or suppress the influence of leakage magnetic flux on the outside. Furthermore, the converter according to the present disclosure also allows for fine adjustment of the inductance.

(11) A power conversion device according to the present disclosure includes the converter according to (10) described above.

The power conversion device according to the present disclosure can reduce losses caused by leakage magnetic flux or suppress the influence of leakage magnetic flux on the outside. Furthermore, the power conversion device according to the present disclosure also allows for fine adjustment of the inductance.

### Details of Embodiments of the Present Disclosure

Specific examples of the embodiments of the present disclosure are described with reference to the drawings. The same reference numerals in the drawings denote the same elements. Note that the present invention is not limited to the configurations shown in the embodiments, but is defined by the claims, and includes all modifications within the meaning and scope equivalent to the claims.

### EMBODIMENTS

### <Reactor>

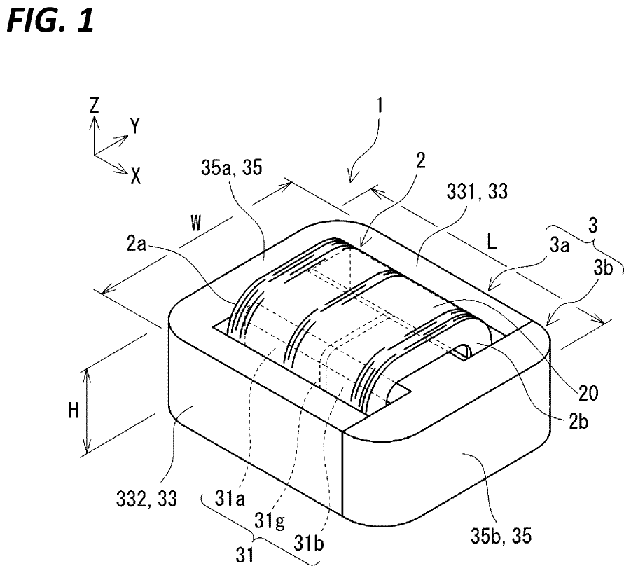

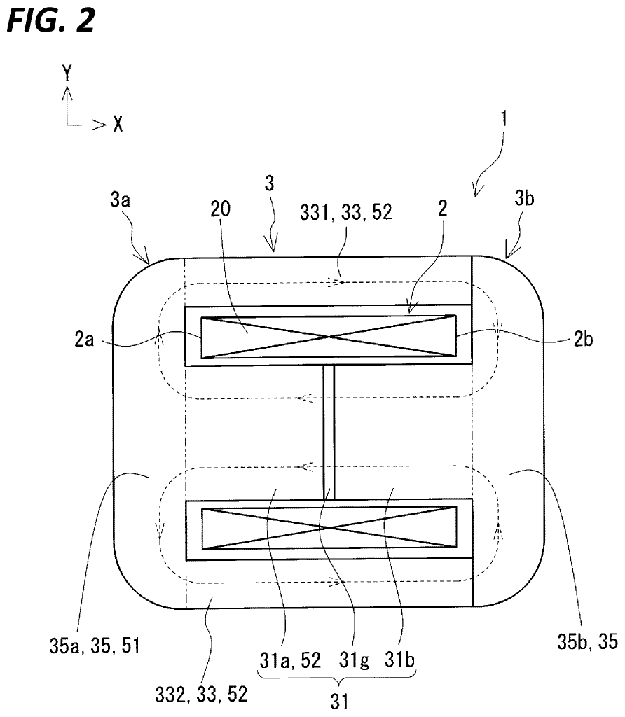

With reference to FIGS. 1 to 5, a reactor 1 according to an embodiment will be described. As shown in FIGS. 1 and 2, the reactor 1 includes a coil 2 and a magnetic core 3. The magnetic core 3 includes a plurality of core pieces including a first core piece 3a. The first core piece 3a is constituted by a molded body of a composite material. One feature of the first core piece 3a is that soft magnetic powder 91 contained in the first core piece 3a is partially anisotropic. Hereinafter, the configuration of the reactor 1 will be described in detail.

### <<Coil>>

As shown in FIGS. 1 and 2, the coil 2 includes at least one winding portion 20. In this example, one winding portion 20 is provided. The winding portion 20 is formed by spirally winding a wire. The wire is, for example, a coated rectangular wire having a conductor wire and an insulating coating that covers the conductor wire. The conductor wire is, for example, a flat wire made of copper. The insulating coating is, for example, made of enamel. The coil 2 in this example is an edgewise coil formed by spirally winding a coated rectangular wire.

The coil 2 has a tubular shape. The shape of the coil 2 may be a polygonal tubular shape or a cylindrical shape. The term “polygonal tubular shape” means that the contour shape of an end surface of the coil 2, i.e., an end surface of the winding portion 20, is a polygonal shape. Examples of the polygonal shape include quadrilateral, hexagonal, and octagonal shapes. The quadrilateral shape includes rectangular shapes. The rectangular shape includes square shapes. For example, the quadrilateral includes not only geometrically defined quadrilaterals, but also shapes that have been modified in detail, such as s shape formed by rounding at least one of the four corners. The term “cylindrical shape” means that the contour shape of the end surface of the coil 2 is a circular shape. The circular shape includes not only perfect circles but also oval shapes. The oval shapes include elliptical shapes. In this example, the shape of the coil 2 is a rectangular tubular shape.

The coil 2 has a first end 2a and a second end 2b. Although omitted in FIG. 1, the end portions of the wire are drawn out from the first end 2a and the second end 2b, respectively. The end portions of the wire are drawn out, for example, upward in FIG. 1, i.e., in the Z-axis direction. The end portions of the wire are connected to a bus bar (not shown). The bus bar connects the coil 2 to a power supply (not shown).

### <<Magnetic Core>>

The coil 2 is disposed within the magnetic core 3. As shown in FIGS. 1 and 2, the magnetic core 3 in this example includes a middle core portion 31, side core portions 33, and end core portions 35. In FIG. 2, the boundaries between the middle core portion 31 and the end core portions 35, and between the side core portions 33 and the end core portions 35, are indicated by two-dot chain lines. As shown in FIG. 2, the magnetic core 3 has a θ shape in plan view.

The magnetic core 3 forms a θ-shaped closed magnetic path. When current flows through the coil 2, magnetic flux flows through the magnetic core 3. The magnetic flux generated by the coil 2 flows from the middle core portion 31, through the end core portions 35 and the side core portions 33, and returns to the middle core portion 31. The dashed arrows in FIG. 2 indicate the flow of magnetic flux.

The end core portions 35, the middle core portion 31, and the side core portions 33 extend in directions orthogonal to each other. The end core portions 35 extend in a direction orthogonal to the axis of the coil 2. The middle core portion 31 and the side core portions 33 each extend in a direction along the axis of the coil 2. That is to say, the middle core portion 31 and the side core portions 33 each extend in a direction orthogonal to the direction in which the end core portions 35 extend. As shown in FIG. 2, when the closed magnetic path is formed in the magnetic core 3, the direction in which each core portion constituting the magnetic core 3 extends coincides with the direction of the magnetic flux flowing through the core portion. That is to say, magnetic flux flows in each core portion along the direction in which the core portion extends. The phrase “direction in which a core portion extends” means the direction along the longest edge of the core portion. Hereinafter, the configuration of each core portion in the magnetic core 3 will be described in detail.

In the following description, the X-axis direction, Y-axis direction, and Z-axis direction are defined as follows. The X-axis direction is a direction along the axis of the coil 2. The Y-axis direction is the direction orthogonal to the axis of the coil 2, i.e., the direction orthogonal to the X-axis direction, and is the direction in which the middle core portion 31 and the side core portions 33 are disposed in parallel. The Z-axis direction is the direction orthogonal to both the X-axis direction and the Y-axis direction. The Z-axis direction is a direction perpendicular to the XY plane.

### (End Core Portions)

The end core portions 35 are disposed outside the coil 2. The end core portions 35 are disposed to face the end surfaces of the coil 2 and extend in a direction orthogonal to the axis of the coil 2. The direction in which the end core portions 35 extend is the Y-axis direction. In this example, the shape of each end core portion 35 is substantially rectangular parallelepiped.

Two end core portions 35 are provided. The end core portions 35 include a first end core portion 35a and a second end core portion 35b. The first end core portion 35a faces the first end 2a of the coil 2. The second end core portion 35b faces the second end 2b of the coil 2. The first end core portion 35a and the second end core portion 35b are disposed in parallel, with a gap therebetween in the X-axis direction.

### (Middle Core Portion)

The middle core portion 31 is disposed inside the winding portion 20 of the coil 2. In this example, one middle core portion 31 is provided. The middle core portion 31 extends in a direction along the axis of the coil 2. The direction in which the middle core portion 31 extends is the X-axis direction. The length of the middle core portion 31 is equal to or greater than the length of the coil 2. The “length” mentioned here refers to the length in the X-axis direction. The two end portions of the middle core portion 31 may respectively protrude from the two end surfaces of the coil 2. These protruding portions are also part of the middle core portion 31. The shape of the middle core portion 31 corresponds to the inner shape of the coil 2. In this example, the shape of the middle core portion 31 is substantially rectangular parallelepiped.

The middle core portion 31 is disposed between the first end core portion 35a and the second end core portion 35b. A first end portion of the middle core portion 31 is coupled to the first end core portion 35a. A second end portion of the middle core portion 31 is coupled to the second end core portion 35b. The phrase “coupled” means that the components are joined and inseparable. For example, the middle core portion 31 may be integrally molded with the first end core portion 35a, and the middle core portion 31 may be connected to the second end core portion 35b. The middle core portion 31 and the second end core portion 35b may be connected, for example, by bonding with an adhesive or by integrating them using a resin molded member, which will be described later.

In this example, the middle core portion 31 includes a first middle core portion 31a and a second middle core portion 31b. The first middle core portion 31a and the second middle core portion 31b are disposed in series in the direction in which the middle core portion 31 extends, i.e., in the X-axis direction. The first middle core portion 31a is integrally molded with the first end core portion 35a. The second middle core portion 31b is integrally molded with the second end core portion 35b. The lengths of the first middle core portion 31a and the second middle core portion 31b can be set as needed. The lengths of the first middle core portion 31a and the second middle core portion 31b may be the same or different.

In this example, the middle core portion 31 includes a gap portion 31g. The gap portion 31g is provided between the first middle core portion 31a and the second middle core portion 31b. By including the gap portion 31g in the middle core portion 31, the inductance of the reactor 1 can be adjusted. The gap portion 31g is located inside the coil 2. When the gap portion 31g is located inside the coil 2, the leakage magnetic flux from the gap portion 31g is reduced compared to the case where the gap portion 31g is exposed from the coil 2. The gap portion 31g may be an air gap. The gap portion may be formed of a non-magnetic material made of, for example, resin or ceramic. The gap portion 31g may be omitted. When the gap portion 31g is omitted, the first middle core portion 31a and the second middle core portion 31b are in contact with each other, and there is substantially no gap between the first middle core portion 31a and the second middle core portion 31b.

### (Side Core Portions)

The side core portions 33 are disposed outside the coil 2. The side core portions 33 are disposed in parallel with the middle core portion 31 so as to sandwich the coil 2. The side core portions 33 extend in a direction along the axis of the coil 2. The direction in which the side core portions 33 extend is the X-axis direction.

The side core portions 33 are disposed between the first end core portion 35a and the second end core portion 35b. First end portions of the side core portions 33 are coupled to the first end core portion 35a. The second end portions of the side core portions 33 are coupled to the second end core portion 35b. In this example, the side core portions 33 are integrally molded with the first end core portion 35a, and the side core portions 33 are connected to the second end core portion 35b. The length of the side core portions 33 is equivalent to the length of the middle core portion 31. In this example, the shape of the side core portions 33 is substantially rectangular parallelepiped.

Two side core portions 33 are provided. The side core portions 33 includes a first side core portion 331 and a second side core portion 332. The first side core portion 331 and the second side core portion 332 are disposed in parallel, with a gap therebetween in the Y-axis direction. In this example, the first side core portion 331 and the second side core portion 332 are disposed symmetrically with respect to the center line of the middle core portion 31.

### <Core Pieces>

The magnetic core 3 is composed of a plurality of core pieces. As shown in FIGS. 1 and 2, the magnetic core 3 in this example includes the first core piece 3a and a second core piece 3b. The magnetic core 3 is formed by combining the first core piece 3a and the second core piece 3b. In this example, the first core piece 3a is E-shaped, and the second core piece 3b is T-shaped. The magnetic core 3 is an E-T type core formed by combining the E-shaped first core piece 3a and the T-shaped second core piece 3b.

### (First Core Piece)

The first core piece 3a is a core piece that constitutes part of the magnetic core 3. As shown in FIG. 2, the first core piece 3a includes a first core portion 51 and a second core portion 52. The first core portion 51 and the second core portion 52 extend in directions orthogonal to each other. Hereinafter, the configuration of the first core piece 3a according to an embodiment will be described.

The first core piece 3a includes at least one of the total three core portions including one middle core portion 31 and two side core portions 33, and an end core portion 35. In this example, the first core piece 3a includes the first end core portion 35a, the first middle core portion 31a, and the side core portions 33. The side core portions 33 include the first side core portion 331 and the second side core portion 332. The first end core portion 35a, the first middle core portion 31a, the first side core portion 331, and the second side core portion 332 are integrally molded. The first core piece 3a is an integrally molded component. In FIG. 2, the boundaries between the first end core portion 35a and the middle core portion 31, and between the first end core portion 35a and the side core portions 33, are shown by two-dot chain lines.

The first core piece 3a is E-shaped in plan view. The first end core portion 35a extends in the Y-axis direction. The first middle core portion 31a, the first side core portion 331, and the second side core portion 332 each extend from the first end core portion 35a in the X-axis direction. In this example, the first end core portion 35a is the first core portion 51 in claim 1. The first middle core portion 31a, the first side core portion 331, and the second side core portion 332 are the second core portion 52 in claim 1.

### (Material)

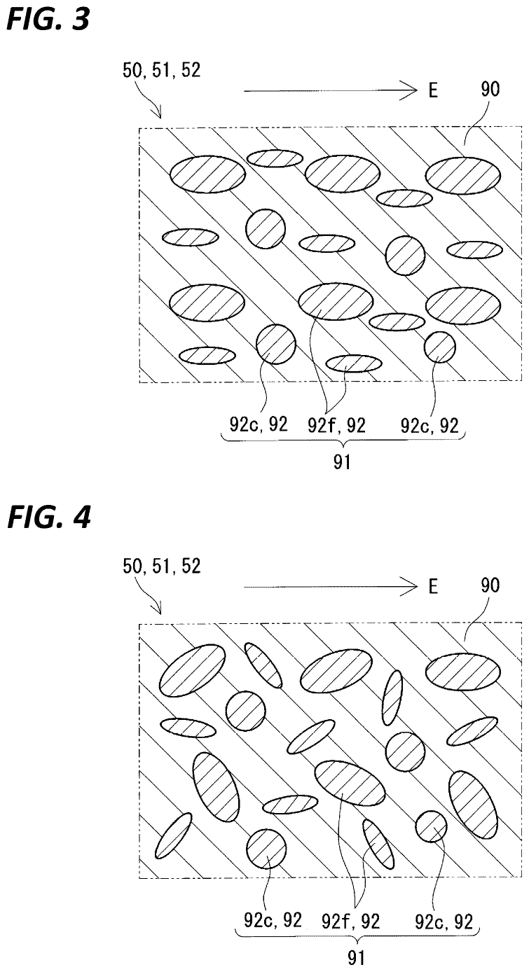

The first core piece 3a is a molded body of a composite material. As shown in FIG. 3, the molded body of the composite material has a structure in which the soft magnetic powder 91 is dispersed in resin 90.

The soft magnetic powder 91 is constituted by a plurality of particles 92. The particles 92 are at least one selected from the group consisting of soft magnetic metal particles, soft magnetic metal particles each coated with an insulating layer on its outer surface, and soft magnetic non-metal particles. The soft magnetic metal is, for example, pure iron or an iron-based alloy. The iron-based alloy is, for example, an Fe (iron)-Si (silicon) alloy or an Fe—Ni (nickel) alloy. The insulating coating is, for example, a phosphate. The soft magnetic non-metal is, for example, ferrite.

The plurality of particles 92 in this example include round particles 92c and elongated particles 92f. The term “round particles 92c” refers to particles 92 whose aspect ratio is less than 1.5 in a cross section of the particles 92. The term “elongated particles 92f” refers to particles 92 whose aspect ratio is 1.5 or more in a cross-section of the particles 92. The aspect ratio of the particles 92 will be described later. The round particles 92c and the elongated particles 92f are included in the soft magnetic powder 91 before the composite material is molded. The shape of the particles 92 is substantially unchanged before and after the molding of the composite material. That is to say, the shape of the particles 92 is substantially maintained even after the molding of the composite material.

The resin 90 may be a thermosetting resin or a thermoplastic resin. The thermosetting resin is, for example, unsaturated polyester resin, epoxy resin, urethane resin, or silicone resin. The thermoplastic resin is, for example, polyphenylene sulfide resin, polytetrafluoroethylene resin, liquid crystal polymer, polyamide resin, polybutylene terephthalate resin, or acrylonitrile-butadiene-styrene resin. The polyamide resin is, for example, nylon 6, nylon 66, or nylon 9T. In addition, the resin 90 may also be, for example, BMC (Bulk Molding Compound), millable silicone rubber, or millable urethane rubber. BMC is a mixture of, for example, unsaturated polyester and calcium carbonate or glass fiber.

The content of the soft magnetic powder 91 in the molded body of the composite material is, for example, not less than 20 vol % and not more than 80 vol %, based on 100 vol % of the molded body of the composite material. Furthermore, the content of the soft magnetic powder 91 may also be in any of the following ranges: not less than 30 vol % and not more than 80 vol %; not less than 50 vol % and not more than 80 vol %; or not less than 60 vol % and not more than 80 vol %. The content of the soft magnetic powder is regarded as equivalent to the area proportion of the soft magnetic powder in a cross-section of the molded body. The content of the soft magnetic powder can be determined as follows. Across-section of the molded body is observed using a scanning electron microscope (SEM), and observation images are acquired. The magnification of the SEM is, for example, not less than 200× and not more than 500×. The number of observation images acquired is 10 or more. The total area of the observation images is 0.1 cm² or more. One observation image may be acquired per cross-section, or a plurality of observation images may be acquired per cross-section. The acquired observation images are subjected to image processing to extract the outlines of the soft magnetic particles. The image processing is, for example, binarization processing. The total area of soft magnetic particles is calculated in each observation image, and the area proportion of the soft magnetic powder in each observation image is determined. The average value of the area proportions across all observation images is regarded as the content of the soft magnetic powder.

The molded body of the composite material exhibits changes in magnetic properties depending on the content of the soft magnetic powder 91. The higher the content of the soft magnetic powder 91, the more likely the magnetic properties improve. The magnetic properties include, for example, relative permeability and saturation magnetic flux density. The molded body of the composite material allows easy adjustment of the content of soft magnetic powder. Therefore, the molded body of the composite material allows easy adjustment of magnetic properties. The relative permeability of the molded body of the composite material is, for example, not less than 5 and not more than 50. Furthermore, the relative permeability of the molded body of the composite material may also be in any of the following ranges: not less than 10 and not more than 45; not less than 15 and not more than 40; or not less than 20 and not more than 35.

The molded body of the composite material may contain a filler (not shown) in addition to the resin 90 and the soft magnetic powder 91. The filler may be a ceramic filler made of, for example, alumina or silica. Including the filler in the molded body of the composite material can enhance heat dissipation. The content of the filler is, for example, not less than 0.2 mass % and not more than 20 mass % when the total volume of the molded body of the composite material is 100 vol %. Furthermore, the content of the filler may also be in any of the following ranges: not less than 0.3 mass % and not more than 15 mass %; or not less than 0.5 mass % and not more than 10 mass %.

### (Anisotropy)

The first core piece 3a is partially anisotropic. The phrase “partially anisotropic” means that in at least one core portion 50 included in the first core piece 3a, the soft magnetic powder 91 is oriented, as shown in FIG. 3. The phrase “soft magnetic powder is oriented” refers to a state in which the orientations of the soft magnetic powder 91 are generally aligned in the same direction. The anisotropic core portion 50 has different relative permeabilities depending on the direction. The anisotropic core portion 50 allows magnetic flux to pass more easily in the direction in which the soft magnetic powder 91 is oriented. Therefore, the relative permeability is higher in the direction in which the soft magnetic powder 91 is oriented. For example, in the first end core portion 35a shown in FIG. 2, the soft magnetic powder is oriented in the Y-axis direction, whereas in the first middle core portion 31a and the side core portion 33, the soft magnetic powder is not oriented in any direction.

In this embodiment, the soft magnetic powder 91 is oriented in different directions in the first core portion 51 and the second core portion 52 shown in FIG. 2. In at least one core portion 50 of the first core portion 51 and the second core portion 52, as shown in FIG. 3, the soft magnetic powder 91 is oriented in a direction E in which the core portion 50 extends. In this embodiment, the first core portion 51 is the first end core portion 35a. The second core portion 52 is at least one of the first middle core portion 31a, the first side core portion 331, and the second side core portion 332. The phrase “oriented in different directions” means that the orientation directions of the soft magnetic powder in the first core portion 51 and the second core portion 52 are not the same. That is to say, the phrase includes a case where the soft magnetic powder is oriented in the direction in which each of the first core portion 51 and the second core portion 52 extends, and a case where the soft magnetic powder is oriented in the direction in which one of the first core portion 51 and the second core portion 52 extends, while the soft magnetic powder is not oriented in the other core portion. The phrase “the soft magnetic powder is not oriented” refers to a random state of orientation of the soft magnetic powder 91, as shown in FIG. 4, and means that the soft magnetic powder 91 is not oriented in any direction. The core portion 50 in which the soft magnetic powder 91 is not oriented is isotropic. The isotropic core portion 50 has almost the same relative permeability regardless of direction. That is to say, the relative permeability is substantially the same in all directions.

As shown in FIG. 3, when the soft magnetic powder 91 is oriented, the degree of orientation is, for example, more than 50%. The phrase “degree of orientation of the soft magnetic powder” refers to the proportion of particles 92 that are oriented in a specific direction among all particles constituting the soft magnetic powder 91. The specific direction is any one of the X-axis direction, the Y-axis direction, and the Z-axis direction. A higher degree of orientation of the soft magnetic powder results in higher relative permeability in the specific direction compared to when the soft magnetic powder 91 is not oriented. Furthermore, the degree of orientation of the soft magnetic powder may be 60% or more, 70% or more, or 75% or more.

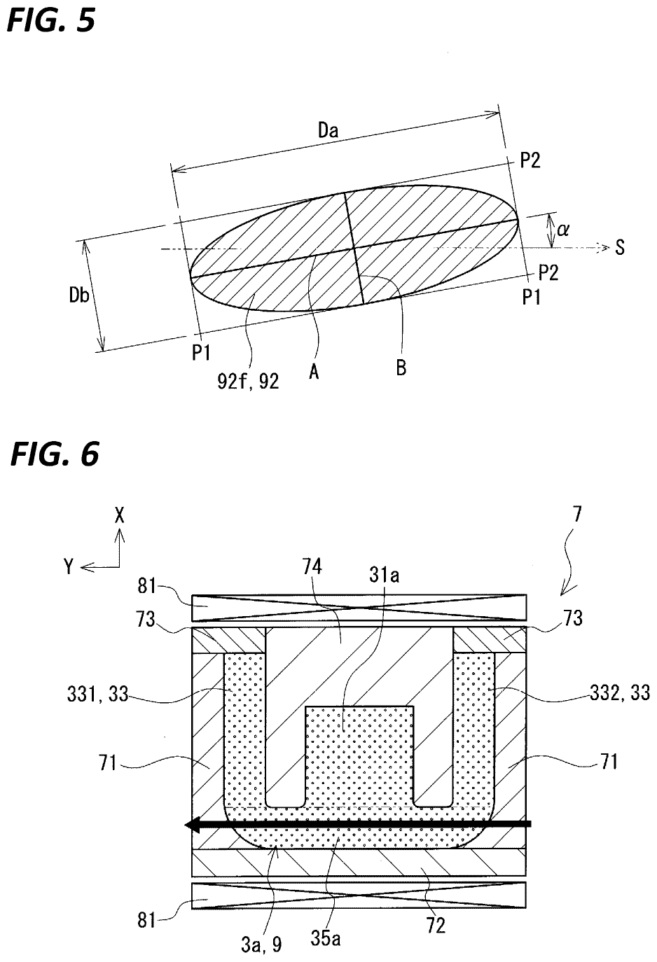

The degree of orientation of the soft magnetic powder can be determined as follows. As shown in FIG. 3, a cross-section of a core portion 50 is observed with a microscope such as an SEM. All particles 92 within an observation field are extracted. All elongated particles 92f having an aspect ratio of 1.5 or more are selected from among all particles 92. As shown in FIG. 5, an inclination a of the major axis A of each elongated particle 92f with respect to a specific direction S is measured. The elongated particles 92f whose inclination a is within ±150 are regarded as being oriented in the specific direction S. The ratio of the number of oriented elongated particles to the total number of elongated particles is defined as the degree of orientation of the soft magnetic powder in the specific direction S.

The size of the observation field is set such that 50 or more elongated particles 92f are included within the observation field. That is to say, the inclination a described above is examined for 50 or more elongated particles 92f per observation field, and the degree of orientation of the soft magnetic powder with respect to the specific direction S is determined. The proportion of the elongated particles 92f among the plurality of particles 92 is, for example, 30% or more, based on 100% of the total number of particles 92. The higher the proportion of the elongated particles 92f, the more likely a high relative permeability due to the orientation of the soft magnetic powder 91 can be achieved. The proportion of the elongated particles 92f may be 40% or more. The proportion of the elongated particles 92f may also be in any of the following ranges: not less than 30% and not more than 100%; not less than 40% and not more than 100%; not less than 50% and not more than 90%; or not less than 60% and not more than 80%.

The aspect ratio of each particle 92 is represented by a ratio Da/Db of the length Da of the major axis A to the length Db of the minor axis B. The major axis A of each particle 92 is, among line segments orthogonal to two parallel lines P1 that sandwich the particle 92, the line segment that corresponds to the maximum distance between the parallel lines P1. The length Da corresponds to the distance between the two parallel lines P1 when the distance between the parallel lines P1 is at its maximum. The minor axis B of each particle 92 is the line segment that has the maximum length among the line segments orthogonal to the major axis A. When two parallel lines P2 that are parallel to the major axis A sandwich the particle 92, the length Db corresponds to the distance between the parallel lines P2.

To check whether or not the soft magnetic powder 91 is oriented in the X-axis direction, the cross-section of the core portion 50 parallel to the XY plane or the XZ plane is to be observed. To check whether or not the soft magnetic powder 91 is oriented in the Y-axis direction, the cross-section of the core portion 50 parallel to the XY plane or the YZ plane is to be observed. To check whether or not the soft magnetic powder 91 is oriented in the Z-axis direction, the cross-section of the core portion 50 parallel to the XZ plane or the YZ plane is to be observed. For example, to check whether or not the soft magnetic powder in the first end core portion 35a is oriented in the Y-axis direction, the cross-section of the first end core portion 35a parallel to the XY plane is to be observed. In this case, the specific direction S shown in FIG. 5 is the Y-axis direction. For example, to check whether or not the soft magnetic powder in the first middle core portion 31a or the side core portions 33 is oriented in the X-axis direction, the cross-section of the first middle core portion 31a or side core portions 33 parallel to the XY plane is to be observed. In this case, the specific direction S shown in FIG. 5 is the X-axis direction. The observation location excludes the area where the first core portion 51 and the second core portion 52 shown in FIG. 2 intersect each other. The observation location is, for example, 2 mm or more away from the intersection.

If the degree of orientation of the soft magnetic powder in the X-axis direction exceeds 50%, the soft magnetic powder 91 is considered to be oriented in the X-axis direction. A core portion 50 in which the soft magnetic powder 91 is oriented in the X-axis direction is anisotropic in the X-axis direction and has a high relative permeability in the X-axis direction. If the degree of orientation of the soft magnetic powder in the Y-axis direction exceeds 50%, the soft magnetic powder 91 is considered to be oriented in the Y-axis direction. A core portion 50 in which the soft magnetic powder 91 is oriented in the Y-axis direction is anisotropic in the Y-axis direction and has a high relative permeability in the Y-axis direction. If the degree of orientation of the soft magnetic powder in the Z-axis direction exceeds 50%, the soft magnetic powder 91 is considered to be oriented in the Z-axis direction. A core portion 50 in which the soft magnetic powder 91 is oriented in the Z-axis direction is anisotropic in the Z-axis direction and has a high relative permeability in the Z-axis direction. If the degree of orientation of the soft magnetic powder is 50% or less in each of the X-axis, Y-axis, and Z-axis directions, the soft magnetic powder 91 is considered to be not oriented in any direction.

As shown in FIG. 2, when a closed magnetic path is formed in the magnetic core 3, magnetic flux flows through each core portion of the magnetic core 3 in the direction in which the core portion extends. In the first end core portion 35a, if the soft magnetic powder is oriented in the direction in which the first end core portion 35a extends, i.e., in the Y-axis direction, the relative permeability in the Y-axis direction is high. As a result, leakage magnetic flux from the first end core portion 35a can be reduced. Since the leakage magnetic flux is reduced, it becomes easier to suppress the linkage of the leakage magnetic flux with the wire that constitutes the coil 2. Losses in the coil caused by leakage magnetic flux are reduced. Furthermore, since the soft magnetic powder is oriented in the direction in which the magnetic flux flows, the variation in the magnetic flux linked with the coil 2 becomes relatively large. As a result, the inductance slightly increases.

In the first middle core portion 31a, if the soft magnetic powder is oriented in the direction in which the first middle core portion 31a extends, i.e., in the X-axis direction, the relative permeability in the X-axis direction is high. As a result, leakage magnetic flux from the first middle core portion 31a can be reduced. Since the leakage magnetic flux is reduced, it becomes easier to suppress the linkage of the leakage magnetic flux with the wire that constitutes the coil 2. Losses in the coil caused by leakage magnetic flux are reduced. In particular, when the gap portion 31g is provided, leakage magnetic flux is likely to occur near the gap portion 31g. As the relative permeability of the first middle core portion 31a in the X-axis direction increases, the leakage magnetic flux near the gap portion 31g is reduced. Furthermore, since the soft magnetic powder is oriented in the direction in which the magnetic flux flows, the variation in the magnetic flux linked with the coil 2 becomes large. As a result, the inductance increases.

In each side core portion 33, if the soft magnetic powder is oriented in the direction in which the side core portion 33 extends, i.e., in the X-axis direction, the relative permeability in the X-axis direction is high. As a result, leakage magnetic flux to the outside from the side core portion 33 is reduced. Since the leakage magnetic flux is reduced, it becomes easier to suppress the influence of the leakage magnetic flux on the outside. For example, the influence of the leakage magnetic flux on a device disposed near a side core portion 33 can be reduced. Furthermore, since the soft magnetic powder is oriented in the direction in which the magnetic flux flows, the variation in the magnetic flux linked with the coil 2 becomes relatively large. As a result, the inductance slightly increases. However, since the leakage magnetic flux from the side core portion 33 to the coil 2 slightly increases, the losses in the coil slightly increase.

### <Method for Manufacturing First Core Piece>

The first core piece 3a is manufactured by placing, into a mold, a composite material in which unsolidified resin and soft magnetic powder are mixed, and molding the composite material. When molding the composite material, a magnetic field is applied before the resin solidifies. By applying a magnetic field, the soft magnetic powder is oriented in the same direction as the magnetic field. By curing the resin in the state where the soft magnetic powder is oriented, an anisotropic first core piece 3a is obtained. For example, when a magnetic field is applied in the Y-axis direction, the soft magnetic powder is oriented in the Y-axis direction. When a magnetic field is applied in the X-axis direction, the soft magnetic powder is oriented in the X-axis direction. If no magnetic field is applied, the soft magnetic powder is not oriented, and an anisotropic first core piece 3a is obtained. The stronger the magnetic field, the more likely the soft magnetic powder is oriented in the same direction as the magnetic field. The magnitude of the magnetic field is, for example, 15 kOe (approximately 1.19×10⁶ A/m) or more. The magnitude of the magnetic field may further be 18 kOe (approximately 1.43×10⁶ A/m) or more, or 20 kOe (15.9×10⁶ A/m) or more.

If the magnetic field is applied to the entire mold, the soft magnetic powder is oriented in the same direction in all of the core portions included in the first core piece 3a. Therefore, unlike the first core piece 3a according to the present embodiment, all of the core portions are anisotropic in the same direction. For example, if a magnetic field in the Y-axis direction is applied to the entire mold, the soft magnetic powder in all of the core portions, i.e., the first end core portion 35a, the first middle core portion 31a, and the side core portions 33, is oriented in the Y-axis direction. That is to say, the orientation direction of the soft magnetic powder in the first core portion 51 and the second core portion 52 is the Y-axis direction. Not only the first end core portion 35a is anisotropic in the Y-axis direction, but also the first middle core portion 31a and the side core portions 33 are anisotropic in the Y-axis direction.

In order to manufacture the first core piece 3a in which the orientation directions of the soft magnetic powder in the first core portion 51 and the second core portion 52 are different, as in the present embodiment, it is necessary to apply a magnetic field partially during the molding of the composite material. For example, the mold is formed such that a magnetic field in the Y-axis direction is applied to the first end core portion 35a, while no magnetic field is applied to the first middle core portion 31a and the side core portions 33. When the mold is formed in this way, the first end core portion 35a is anisotropic in the Y-axis direction, while the first middle core portion 31a and the side core portions 33 are isotropic. The mold is formed such that a magnetic field in the X-axis direction is applied to at least one of the first middle core portion 31a and the side core portions 33, and no magnetic field is applied to the first end core portion 35a. When the mold is formed in this way, the first end core portion 35a is isotropic, and at least one of the first middle core portion 31a and the side core portions 33 is anisotropic in the X-axis direction. The mold is formed such that a magnetic field in the Y-axis direction is applied to the first end core portion 35a, and a magnetic field in the X-axis direction is applied to at least one of the first middle core portion 31a and the side core portions 33. When the mold is formed in this way, the first end core portion 35a is anisotropic in the Y-axis direction, and at least one of the first middle core portion 31a and the side core portions 33 is anisotropic in the X-axis direction.

### (Mold)

An example of a mold 7 for molding the first core piece 3a will be described with reference to FIG. 6. The mold 7 shown in FIG. 6 includes first molds 71, a second mold 72, third molds 73, and a fourth mold 74. By combining the first molds 71, the second mold 72, the third molds 73, and the fourth mold 74, a cavity corresponding to the shape of the first core piece 3a is formed inside the mold 7. The cavity is filled with a composite material 9 by, for example, injection molding. The first molds 71 mold the outer surfaces of the side core portions 33. The second mold 72 molds the outer surface of the first end core portion 35a. The third molds 73 mold the end surfaces of the side core portions 33. The fourth mold 74 molds the inner surfaces of the side core portions 33, the inner surface of the first end core portion 35a, and the outer surface and end surface of the first middle core portion 31a.

The mold 7 in this example includes a first magnetic field device 81 that applies a magnetic field. The first magnetic field device 81 applies a magnetic field in the Y-axis direction. The black arrow in FIG. 6 indicates the direction of the magnetic field. The first magnetic field device 81 in this example is a coil. The mold 7 is disposed inside this coil. The central axis of the coil is parallel to the Y-axis direction, and when the coil is excited, a magnetic field in the Y-axis direction is generated inside the coil.

The mold 7 is made of metal such as steel. The material of the mold 7 is, for example, carbon steel, alloy steel, alloy tool steel, or stainless steel. In this example, the first molds 71 are made of a magnetic material. The second mold 72, the third molds 73, and the fourth mold 74 are made of a non-magnetic material.

When the composite material 9 is molded, a magnetic field in the Y-axis direction is applied from the first magnetic field device 81. Since the fourth mold 74 is made of a non-magnetic material, it exhibits low permeability to magnetic flux. It is difficult for magnetic flux in the Y-axis direction to pass through the first middle core portion 31a and the side core portions 33, and magnetic flux in the Y-axis direction passes mostly through only the first end core portion 35a. Therefore, as indicated by the black arrow in FIG. 6, a magnetic field in the Y-axis direction is applied to the first end core portion 35a, and the magnetic field in the Y-axis direction is not easily applied to the first middle core portion 31a and the side core portions 33. Accordingly, it is possible to obtain a first core piece 3a in which the first end core portion 35a is anisotropic in the Y-axis direction, and the first middle core portion 31a and the side core portions 33 are isotropic.

The material of each first mold 71 may be partially changed so that a magnetic field in the Y-axis direction is applied only to the first end core portion 35a. For example, in each first mold 71 shown in FIG. 6, only the portion located at the end portion of the first end core portion 35a, i.e., the lower portion in FIG. 6, is made of a magnetic material, and the remaining portion, i.e., the upper portion in FIG. 6, is made of a non-magnetic material. That is to say, each first mold 71 has different materials in the X-axis direction. An iron core (not shown) is disposed on the outside of the portion made of a magnetic material of each first mold 71. The iron core is a C-shaped iron core that forms a magnetic path in the Y-axis direction through the first end core portion 35a. The first end core portion 35a is placed between the two end portions of the C-shaped iron core. The dimension of the end portions of the iron core in the X-axis direction is approximately equal to the dimension of the first end core portion 35a in the X-axis direction. A coil (not shown) is wound around the iron core. When the coil is excited, a magnetic field in the Y-axis direction is applied. The magnetic material portion of each first mold 71 allows magnetic flux in the Y-axis direction to pass easily, and a large amount of magnetic flux in the Y-axis direction passes only through the first end core portion 35a.

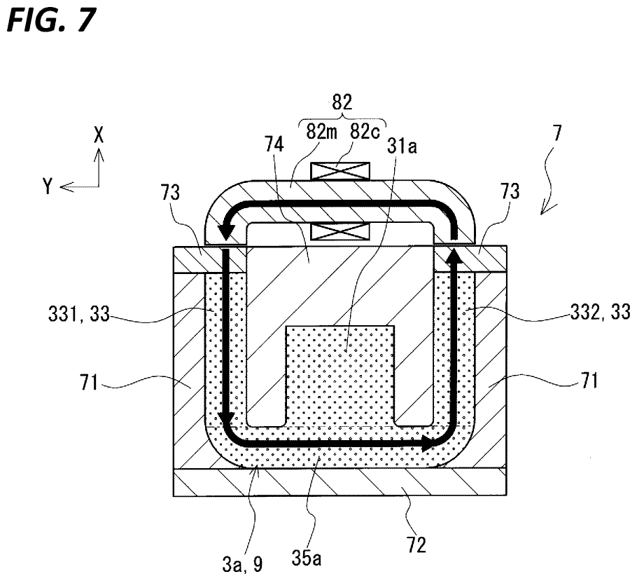

Another example of the mold 7 for molding the first core piece 3a will be described with reference to FIG. 7. The configuration of the mold 7 shown in FIG. 7 is basically the same as the configuration of the mold 7 shown in FIG. 6. Here, differences will be mainly described.

In this example, the third molds 73 are made of a magnetic material. The first molds 71, the second mold 72, and the fourth mold 74 are made of non-magnetic materials. Furthermore, the mold 7 in this example includes a second magnetic field device 82 that applies a magnetic field. The second magnetic field device 82 in this example includes an iron core 82m and a coil 82c. The second magnetic field device 82 is disposed outside (above in FIG. 7) of the third molds 73 and the fourth mold 74. The coil 82c is wound around the iron core 82m. When the coil 82c is excited, the iron core 82m is magnetized.

The iron core 82m in this example is C-shaped. The iron core 82m is disposed to form a closed magnetic path between the side core portions 33 and the first end core portion 35a. Specifically, the C-shaped iron core 82m is disposed so as to connect the two third molds 73 that mold the end surfaces of the first side core portion 331 and the second side core portion 332.

When molding the composite material 9, a magnetic field is applied from the second magnetic field device 82. When the coil 82c is excited, a closed magnetic path is formed, which extends from the iron core 82m, through the first side core portion 331, the first end core portion 35a, and the second side core portion 332, and returns to the iron core 82m, as indicated by the black arrows in FIG. 7. That is to say, a large amount of magnetic flux in the X-axis direction passes through the side core portions 33, and a large amount of magnetic flux in the Y-axis direction passes through the first end core portion 35a. It is difficult for magnetic flux to pass through the first middle core portion 31a. Therefore, a magnetic field in the Y-axis direction is applied to the first end core portion 35a, and a magnetic field in the X-axis direction is applied to the side core portions 33. Magnetic fields in the Y-axis direction and the X-axis direction are not easily applied to the first middle core portion 31a. Accordingly, it is possible to obtain a first core piece 3a in which the first end core portion 35a is anisotropic in the Y-axis direction, the side core portions 33 are anisotropic in the X-axis direction, and the first middle core portion 31a is isotropic.

### (Second Core Piece)

In this example, the second core piece 3b includes the second end core portion 35b and the second middle core portion 31b. The second end core portion 35b and the second middle core portion 31b are integrally molded. The second core piece 3b is an integrally molded product. In FIG. 2, the boundary between the second end core portion 35b and the middle core portion 31 is indicated by a two-dot chain line.

The second core piece 3b is T-shaped in plan view. The second end core portion 35b extends in the Y-axis direction. The second middle core portion 31b extends from the second end core portion 35b in the X-axis direction.

The second core piece 3b may be a compacted body or a molded body of a composite material. In this example, the second core piece 3b is constituted by a compacted body. The compacted body is formed by compression-molding soft magnetic powder. The compacted body contains more soft magnetic powder compared to a molded body of a composite material. Therefore, the compacted body has superior magnetic properties than the molded body of a composite material. The compacted body may include, for example, a binder resin or a molding aid. The soft magnetic powder content in the compacted body is, for example, not less than 85 vol % and not more than 99.99 vol %, based on 100 vol % of the compacted body. The relative permeability of the compacted body is, for example, not less than 50 and not more than 500. Furthermore, the relative permeability of the compacted body may be in any of the following ranges: not less than 100 and not more than 450; or not less than 150 and not more than 400.

The magnetic core 3 in this example is formed by combining the first core piece 3a made of a molded body of a composite material and the second core piece 3b made of a compacted body, and therefore a predetermined inductance can be easily obtained.

### [Modifications]

In the reactor 1 according to the embodiment, the magnetic core 3 is described as an E-T type core as shown in FIG. 2. However, the shapes of the first core piece 3a and the second core piece 3b may be selected from various combinations. For example, the magnetic core 3 may be an E-E type core, an E-I type core, a U-T type core, or an F-F type core. The E-E type core is a structure in which E-shaped core pieces are combined. The E-I type core is a structure in which an E-shaped core piece and an I-shaped core piece are combined. The U-T type core is a structure in which a U-shaped core piece and a T-shaped core piece are combined. The F-F type core is a structure in which F-shaped core pieces are combined.

When the magnetic core 3 is an E-E type core, the first core piece 3a and the second core piece 3b are each E-shaped. The side core portions 33 are each divided into two in the direction in which the side core portions 33 extend. A first part of each side core portion 33 close to the first end core portion 35a is integrally molded with the first end core portion 35a. The remaining part of each side core portion 33 excluding the first part, i.e., a second part close to the second end core portion 35b, is integrally molded with the second end core portion 35b.

When the magnetic core 3 is an E-I type core, the first core piece 3a is E-shaped, and the second core piece 3b is I-shaped. The middle core portion 31 is not divided into the first middle core portion 31a and the second middle core portion 31b. The entire middle core portion 31 is integrally molded with the first end core portion 35a. The first core piece 3a includes the first end core portion 35a, the middle core portion 31, and the side core portions 33. The second core piece 3b includes only the second end core portion 35b.

When the magnetic core 3 is a U-T type core, the first core piece 3a is U-shaped or T-shaped, and the second core piece 3b is T-shaped or U-shaped. The middle core portion 31 is not divided into the first middle core portion 31a and the second middle core portion 31b. When the first core piece 3a is U-shaped, the entire middle core portion 31 is integrally molded with the second end core portion 35b. The first core piece 3a includes the first end core portion 35a and the side core portions 33. The second core piece 3b includes the second end core portion 35b and the middle core portion 31. When the first core piece 3a is T-shaped, the entire middle core portion 31 is integrally molded with the first end core portion 35a. The side core portions 33 are integrally molded with the second end core portion 35b. The first core piece 3a includes the first end core portion 35a and the middle core portion 31. The second core piece 3b includes the second end core portion 35b and the side core portions 33.

When the magnetic core 3 is an F-F type core, the first core piece 3a and the second core piece 3b are each F-shaped. The first core piece 3a includes the first end core portion 35a, the first middle core portion 31a, and the first side core portion 331. The second core piece 3b includes the second end core portion 35b, the second middle core portion 31b, and the second side core portion 332.

### <<Resin Molded Member>>

The reactor 1 may include a resin molded member (not shown). The resin molded member covers at least a portion of the outer peripheral surface of the magnetic core 3. For example, the resin molded member covers the entire surface of the magnetic core 3 exposed from the coil 2 and a portion of the surface of the coil 2. The resin molded member integrates the first core piece 3a and the second core piece 3b. Additionally, the resin molded member integrates the coil 2 and the magnetic core 3.

### <Converter and Power Conversion Device>

The reactor 1 according to the embodiment can be used for applications that satisfy the following energization conditions. The energization conditions are, for example, such that the maximum DC current is not less than 100 A and not more than 1000 A, the average voltage is not less than 100 V and not more than 1000 V, and the operating frequency is not less than 5 kHz and not more than 100 kHz. The reactor 1 according to the embodiment is typically used as a component of a converter mounted in a vehicle such as an electric vehicle or a hybrid vehicle, and as a component of a power conversion device including the converter.

As shown in FIG. 16, a vehicle 1200 such as a hybrid vehicle or an electric vehicle includes a main battery 1210, a power conversion device 1100 connected to the main battery 1210, and a motor 1220 driven by electric power supplied from the main battery 1210 and used for driving. The motor 1220 is typically a three-phase AC motor. The motor 1220 drives wheels 1250 during driving, and functions as a generator during regeneration. In the case of a hybrid vehicle, the vehicle 1200 includes an engine 1300 in addition to the motor 1220. FIG. 16 shows an inlet as the charging point of the vehicle 1200, but a form including a plug may also be adopted.

The power conversion device 1100 includes a converter 1110 that is connected to the main battery 1210, and an inverter 1120 that is connected to the converter 1110 and performs conversion between direct current and alternating current. During driving of the vehicle 1200, the converter 1110 shown in this example steps up the input voltage of the main battery 1210, which is, for example, not less than 200 V and not more than 300 V, to be, for example, not less than 400 V and not more than 700 V, and supplies power to the inverter 1120. During regeneration, the converter 1110 steps down the input voltage output from the motor 1220 via the inverter 1120 to a DC voltage suitable for the main battery 1210 and charges the main battery 1210. The input voltage is a DC voltage. During driving of the vehicle 1200, the inverter 1120 converts the DC voltage stepped up by the converter 1110 into a predetermined AC voltage and supplies power to the motor 1220, and during regeneration, the inverter 1120 converts the AC output from the motor 1220 into a DC voltage and outputs it to the converter 1110.

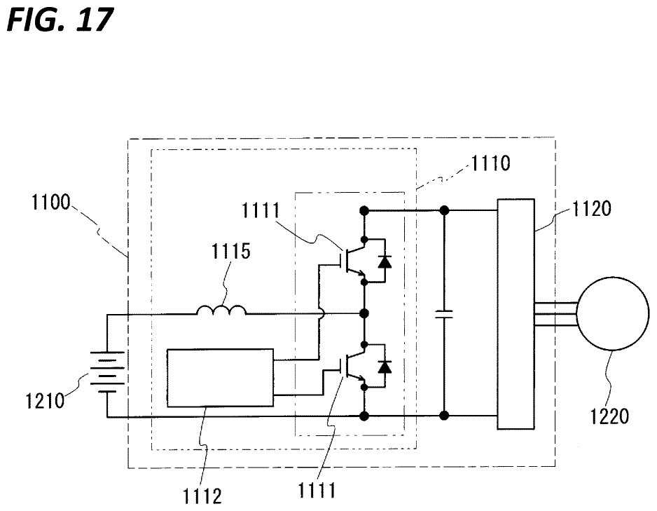

As shown in FIG. 17, the converter 1110 includes a plurality of switching elements 1111, a drive circuit 1112 that controls the operation of the switching elements 1111, and a reactor 1115, and performs voltage conversion of the input voltage by repeating ON and OFF operations. The voltage conversion of the input voltage here refers to step-up or step-down conversion. Power devices such as field-effect transistors and insulated gate bipolar transistors are used as the switching elements 1111. The reactor 1115 utilizes the characteristic of a coil to resist changes in the current flowing through the circuit, and functions to smooth fluctuations when the current increases or decreases due to switching operations. The reactor according to the embodiment is provided as the reactor 1115. By including the reactor according to the embodiment, the losses in the power conversion device 1100 and the converter 1110 are reduced.

The vehicle 1200 includes, in addition to the converter 1110, a power supply converter 1150 connected to the main battery 1210, and an auxiliary power supply converter 1160 connected to both a sub-battery 1230 that serves as a power source for an auxiliary device 1240 and the main battery 1210, and converting the high voltage of the main battery 1210 into a low voltage. The converter 1110 typically performs DC-DC conversion, while the power supply converter 1150 and the auxiliary power supply converter 1160 performs AC-DC conversion. The power supply converter 1150 may perform DC-DC conversion. The reactors of the power supply converter 1150 and the auxiliary power supply converter 1160 may have the same configuration as the reactor according to the embodiment and may be appropriately modified in size, shape, or the like. The reactor according to the embodiment can also be used in converters that perform input power conversion and that perform only step-up or only step-down conversion.

### Test Example 1

A reactor having the same configuration as the reactor 1 according to the embodiment was evaluated for loss and inductance.

In Test Example 1, a test first core piece 3a that is partially anisotropic and a comparison first core piece 3a that is isotropic were designed. In the test first core piece 3a, only the first end core portion 35a among the first end core portion 35a, the first middle core portion 31a, and the side core portions 33 is anisotropic. That is to say, the soft magnetic powder in the first end core portion 35a is oriented in a specific direction, while the soft magnetic powder in the first middle core portion 31a and the side core portions 33 is not oriented. In the comparison first core piece 3a, all of the core portions are isotropic. That is to say, the soft magnetic powder in all of the core portions of the first core piece 3a is not oriented.

A magnetic core 3 including the first core piece 3a and the second core piece 3b was designed. The magnetic core 3 is an E-T type core. The first core piece 3a is a molded body of a composite material. The second core piece 3b is a compacted body. The configuration of the designed magnetic core is shown below.

### (Magnetic Core Size)

The length L of the magnetic core 3: 90 mm
The width W of the magnetic core 3: 68 mm
The height H of the magnetic core 3: 25 mm

The length L is the dimension in the X-axis direction of the magnetic core 3 as shown in FIG. 1. The width W is the dimension in the Y-axis direction of the magnetic core 3. The height H is the dimension in the Z-axis direction of the magnetic core 3.

### (Dimensions of Each Core Portion)

The length of the middle core portion 31: 60 mm
   The lengths of the first middle core portion 31a and the second middle core portion 31b: 29 mm
   The length of the gap portion 31g: 2 mm
The width of the middle core portion 31: 26 mm
The lengths of the side core portions 33: 60 mm
The widths of the side core portions 33: 10 mm
The lengths of the end core portions 35: 15 mm
The widths of the end core portions 35: 68 mm

The length of each core portion is the dimension in the X-axis direction. The width of each core portion is the dimension in the Y-axis direction. The height of each core portion, i.e., the dimension in the Z-axis direction, is 25 mm.

Reactors were designed for Sample No. 0, Sample No. 1X, Sample No. 1Y, and Sample No. 1Z. Sample No. 0 includes the comparison first core piece 3a. Sample No. 1X, Sample No. 1Y, and Sample No. 1Z include the test first core piece 3a. In Sample No. 0, the first end core portion 35a is isotropic. In Sample No. 1X, the first end core portion 35a is anisotropic in the X-axis direction. In Sample No. 1Y, the first end core portion 35a is anisotropic in the Y-axis direction. In Sample No. 1Z, the first end core portion 35a is anisotropic in the Z-axis direction. In Test Example 1, when anisotropy is present in a specific direction, namely X-axis, Y-axis, or Z-axis, the relative permeability in the specific direction is set to be a value that is 200% higher than that in the isotropic case. The relative permeabilities in the remaining directions other than the specific direction are set to be equal to those in the isotropic case.

The loss and inductance of the reactor of each sample were analyzed. For the analysis of loss and inductance, JMAG-Designer 21.0, an electromagnetic field analysis software provided by JSOL Corporation was used and a transient magnetic field analysis was performed.

### (Loss Analysis)

The losses were analyzed when a voltage with a DC current of 0 A, an input voltage of 250 V, an output voltage of 500 V, and a frequency of 20 kHz was applied to the coils. The coil losses were calculated from the magnetic flux density distribution and current density distribution. Table 1 shows the coil loss for each sample. Each coil loss is shown as a ratio relative to the coil loss (100%) of Sample No. 0.

TABLE 1

| | No. 0 | No. 1X | No. 1Y | No. 1Z |
|---|---|---|---|---|
| First End | Isotropic | Anisotropic | Anisotropic | Anisotropic |
| Core Portion | | | | |
| Orientation | — | X | Y | Z |
| Direction | | | | |
| Coil Loss (%) | 100 | 91 | 85 | 100 |

As shown in Table 1, Sample No. 1Y exhibited the lowest coil loss among Sample No. 1X through Sample No. 1Z. The coil loss of Sample No. 1Y is reduced by more than 10% compared to the coil loss of Sample No. 0. The coil loss of Sample No. 1Z is the same as the coil loss of Sample No. 0. These results indicate that when the first end core portion 35a is anisotropic in the Y-axis direction, the coil loss can be more effectively reduced. This is considered to be due to the high relative permeability of the first end core portion 35a in the Y-axis direction, which reduced the leakage magnetic flux from the first end core portion 35a, thereby reducing the coil loss caused by the leakage magnetic flux.

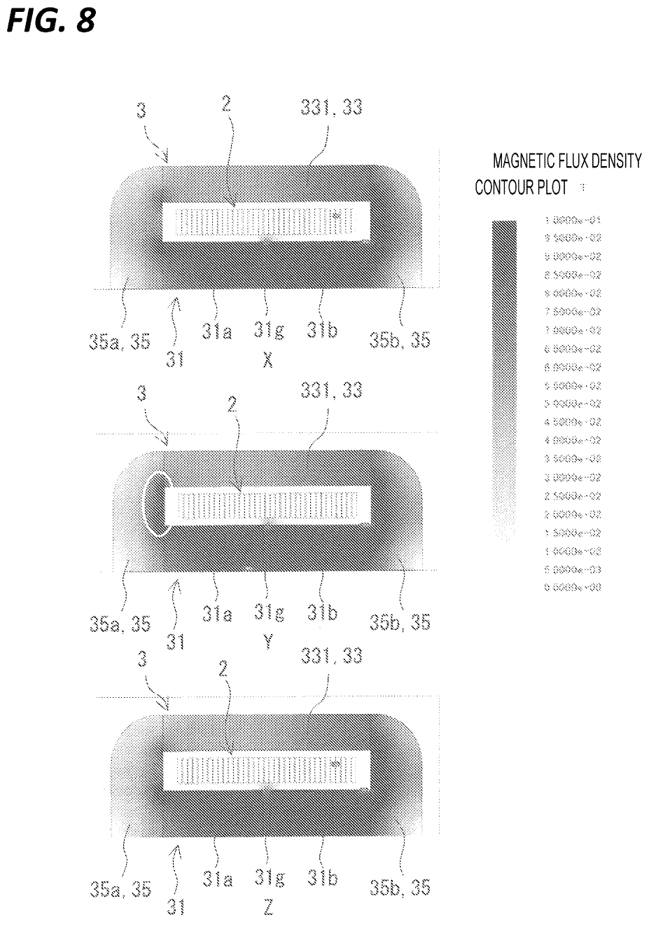

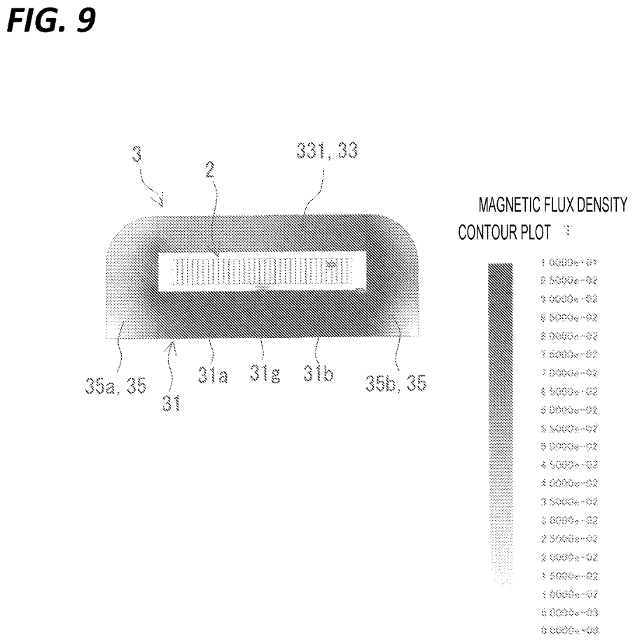

FIGS. 8 and 9 are contour diagrams showing the distribution of magnetic flux density obtained from the analysis. The analysis model was a half model in which the magnetic core 3 was divided into two along the XZ plane passing through the center line of the middle core portion 31. FIG. 8 shows, from top to bottom, the contour diagrams of Sample No. 1X, Sample No. 1Y, and Sample No. 1Z. FIG. 9 shows the contour diagram of Sample No. 0. In the contour diagrams shown in FIGS. 8 and 9, darker areas indicate higher magnetic flux density, and lighter areas indicate lower magnetic flux density.

From the contour diagram of Sample No. 1Y, it can be seen that Sample No. 1Y has a higher magnetic flux density in the area enclosed by the white line, compared to Sample No. 0, Sample No. 1X, and Sample No. 1Z. In FIG. 8, the area enclosed by the white line is the area near an end surface of the coil 2, of the magnetic path from the first middle core portion 31a through the first end core portion 35a to the first side core portion 331. In Sample No. 1Y, a large amount of magnetic flux flows through the first end core portion 35a. In Sample No. 1Y, it can be seen that the leakage magnetic flux from the first end core portion 35a is suppressed. Therefore, there is less leakage magnetic flux shortcutting the junction between the first middle core portion 31a and the first end core portion 35a, and the corner between the first end core portion 35a and the first side core portion 331.

### (Inductance Analysis)

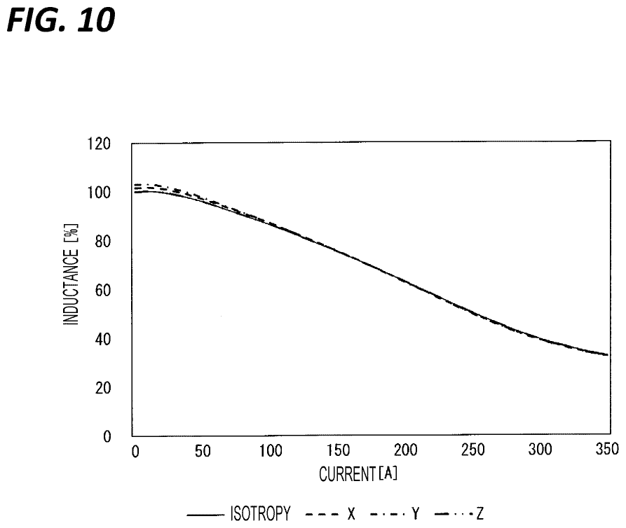

Inductance was analyzed when a current ranging from 0 A to 350 A was applied to the coil. The inductance in each sample is shown in FIG. 10. The inductances in FIG. 10 are shown as ratios relative to the inductance (100%) of Sample No. 0 at a current of 0 A. In FIG. 10, the horizontal axis represents current, and the vertical axis represents inductance. The solid line indicates the inductance of isotropic Sample No. 0. The dashed line indicates the inductance of Sample No. 1X, which is anisotropic in the X-axis direction. The one-dot chain line indicates the inductance of Sample No. 1Y, which is anisotropic in the Y-axis direction. The two-dot chain line indicates the inductance of Sample No. 1Z, which is anisotropic in the Z-axis direction.

As shown in FIG. 10, in the low current range from 0 A to 100 A, the inductance of Sample No. 1Y is higher than the inductance of Sample No. 0. The inductance of Sample No. 1X is slightly higher than the inductance of Sample No. 0. The inductance of Sample No. 1Z is substantially the same as the inductance of Sample No. 0. These results indicate that the inductance increases more when the first end core portion 35a is anisotropic in the Y-axis direction. The inductance is considered to have slightly increased due to the high relative permeability of the first end core portion 35a in the Y-axis direction, which results in a relatively large variation in the magnetic flux linked with the coil 2

### Test Example 2

In Test Example 2, a test first core piece 3a was designed in which only the first middle core portion 31a is anisotropic. In the test first core piece 3a of Test Example 2, the soft magnetic powder in the first middle core portion 31a is oriented in a specific direction, while the soft magnetic powder in the first end core portion 35a and the side core portion 33 is not oriented. Except for the fact that the first middle core portion 31a is the anisotropic core portion in the first core piece 3a, Test Example 2 is the same as Test Example 1.

Reactors were designed for Sample No. 2X, Sample No. 2Y, and Sample No. 2Z. In Sample No. 2X, the first middle core portion 31a is anisotropic in the X-axis direction. In Sample No. 2Y, the first middle core portion 31a is anisotropic in the Y-axis direction. In Sample No. 2Z, the first middle core portion 31a is anisotropic in the Z-axis direction.

The loss and inductance of the reactor of each sample were analyzed. The coil loss and inductance for each sample were obtained in the same manner as in Test Example 1. Table 2 shows the coil loss for each sample. Each coil loss is shown as a ratio relative to the coil loss (100%) of Sample No. 0 in Test Example 1.

TABLE 2

| | No. 0 | No. 2X | No. 2Y | No. 2Z |
|---|---|---|---|---|
| First Middle | Isotropic | Anisotropic | Anisotropic | Anisotropic |
| Core Portion | | | | |
| Orientation | — | X | Y | Z |
| Direction | | | | |
| Coil Loss (%) | 100 | 72 | 100 | 100 |

As shown in Table 2, Sample No. 2X exhibited the lowest coil loss among Sample No. 2X through Sample No. 2Z. The coil loss of Sample No. 2X is reduced by approximately 30% compared to the coil loss of Sample No. 0. The coil losses of Sample No. 2Y and Sample No. 2Z are the same as the coil loss of Sample No. 0. These results indicate that when the first middle core portion 31a is anisotropic in the X-axis direction, the coil loss can be more effectively reduced. This is considered to be due to the high relative permeability of the first middle core portion 31a in the X-axis direction, which reduced the leakage magnetic flux from the first middle core portion 31a, thereby reducing the coil loss caused by the leakage magnetic flux. In particular, it is considered that coil loss is significantly reduced due to the reduction in leakage magnetic flux near the gap portion 31g.

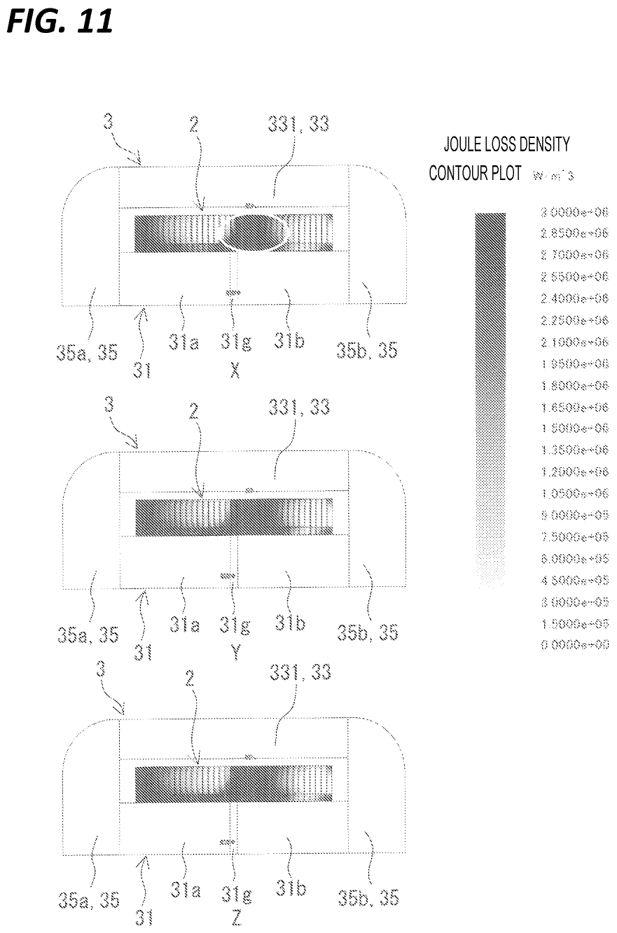

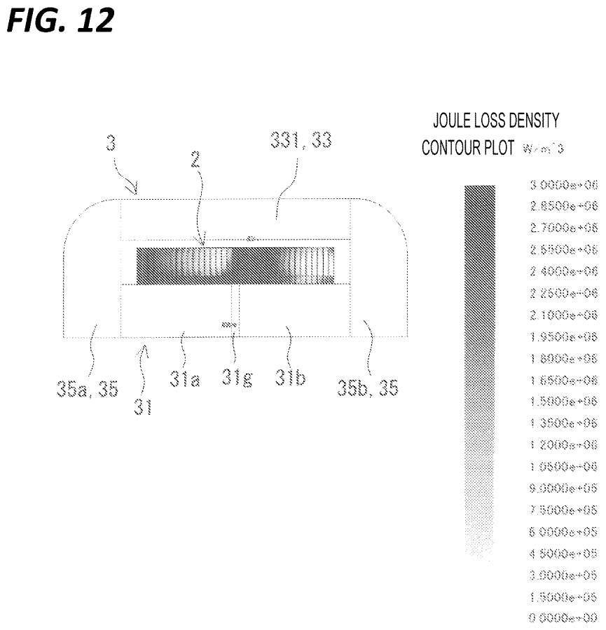

FIGS. 11 and 12 are contour diagrams showing the distribution of Joule loss density in the coil obtained from the analysis. FIG. 11 shows, from top to bottom, the contour diagrams of Sample No. 2X, Sample No. 2Y, and Sample No. 2Z. FIG. 12 shows the contour diagram of Sample No. 0. In the contour diagrams shown in FIGS. 11 and 12, darker areas indicate higher Joule loss density, and lighter areas indicate lower Joule loss density.

From the contour diagram of Sample No. 2X, it can be seen that Sample No. 2X has a lower Joule loss density in the coil 2 in the area enclosed by the white line, compared to Sample No. 0, Sample No. 2Y, and Sample No. 2Z. In the area with low Joule loss density, the amount of leakage magnetic flux entering the coil 2 is considered to be small. In FIG. 11, the area enclosed by the white line corresponds to the area of the coil 2 near the gap portion 31g. Although it is not clearly visible in the figure, in Sample No. 2X, the area enclosed by the white line actually contains more low-density areas compared to Sample No. 0, Sample No. 2Y, and Sample No. 2Z, and the Joule loss density in the area enclosed by the white line is lower. In Sample No. 2X, it can be seen that the leakage magnetic flux entering the coil 2 from the vicinity of the gap portion 31g is suppressed.

### (Inductance Analysis)

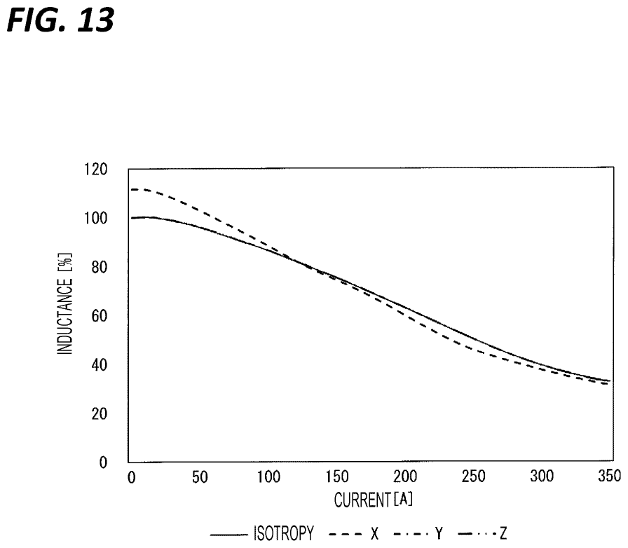

FIG. 13 shows the inductance of each sample. The inductances in FIG. 13 are shown as ratios relative to the inductance (100%) of Sample No. 0 at a current of 0 A. The solid line indicates the inductance of Sample No. 0, which is isotropic. The dashed line indicates the inductance of Sample No. 2X, which is anisotropic in the X-axis direction. The one-dot chain line indicates the inductance of Sample No. 2Y, which is anisotropic in the Y-axis direction. The two-dot chain line indicates the inductance of Sample No. 2Z, which is anisotropic in the Z-axis direction.

As shown in FIG. 13, in the low current range from 0 A to 100 A, the inductance of Sample No. 2X is higher than the inductance of Sample No. 0. The inductance of Sample No. 2X at a current of 0 A is improved by 10% or more compared to the inductance of Sample No. 0. The inductances of Sample No. 2Y and Sample No. 2Z are substantially the same as the inductance of Sample No. 0. These results indicate that inductance increases more when the first middle core portion 31a is anisotropic in the X-axis direction. The inductance is considered to have increased due to the high relative permeability of the first middle core portion 31a in the X-axis direction, which results in a relatively large variation in the magnetic flux linked with the coil 2.

### Test Example 3

In Test Example 3, a test first core piece 3a was designed in which only the side core portions 33 are anisotropic. In the test first core piece 3a of Test Example 3, the soft magnetic powder in the side core portions 33 is oriented in a specific direction, while the soft magnetic powder in the first end core portion 35a and the first middle core portion 31a is not oriented. Except for the fact that the side core portions 33 are the anisotropic core portions in the first core piece 3a, Test Example 3 is the same as Test Example 1.

Reactors were designed for Sample No. 3X, Sample No. 3Y, and Sample No. 3Z. In Sample No. 3X, the side core portions 33 are anisotropic in the X-axis direction. In Sample No. 3Y, the side core portions 33 are anisotropic in the Y-axis direction. In Sample No. 3Z, the side core portions 33 are anisotropic in the Z-axis direction.

The loss and inductance of the reactor of each sample were analyzed. The coil loss and inductance for each sample were obtained in the same manner as in Test Example 1. Table 3 shows the coil loss for each sample. Each coil loss is shown as a ratio relative to the coil loss (100%) of Sample No. 0 in Test Example 1.

TABLE 3

| | No. 0 | No. 3X | No. 3Y | No. 3Z |
|---|---|---|---|---|
| Side Core | Isotropic | Anisotropic | Anisotropic | Anisotropic |
| Portions | | | | |
| Orientation | — | X | Y | Z |
| Direction | | | | |
| Coil Loss (%) | 100 | 102 | 100 | 100 |

As shown in Table 3, the coil losses of Sample No. 3X, Sample No. 3Y, and Sample No. 3Z are substantially the same as the coil loss of Sample No. 0. The coil loss of Sample No. 3X is slightly higher than the coil loss of Sample No. 0, but the difference between the coil losses of Sample No. 3X and Sample No. 0 is slight. When the difference in coil loss is within 3%, it is considered to have almost no impact.

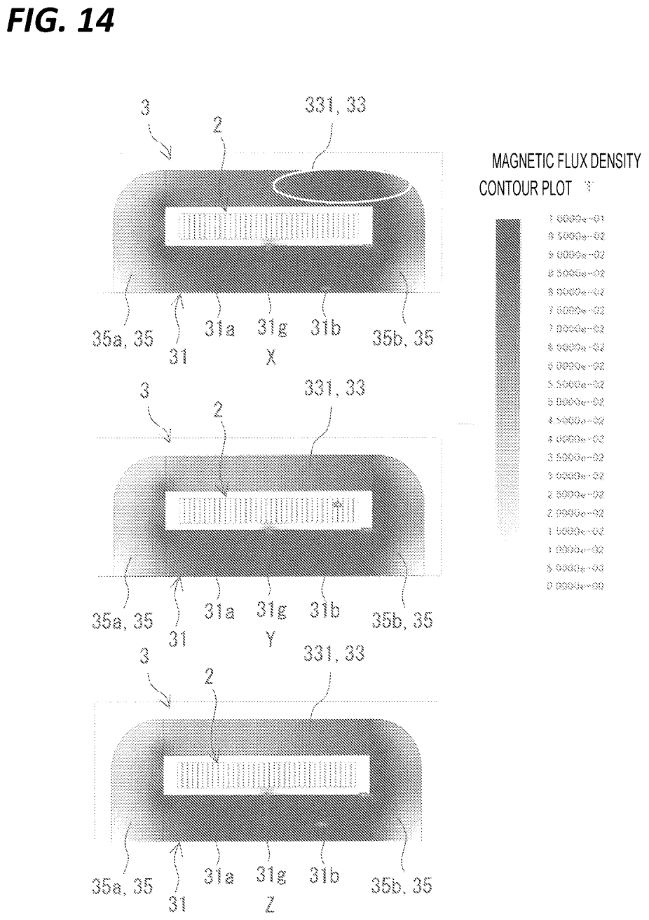

FIG. 14 is a contour diagram showing the distribution of magnetic flux density obtained from the analysis. FIG. 14 shows, from top to bottom, the contour diagrams of Sample No. 3X, Sample No. 3Y, and Sample No. 3Z.

From the contour diagram of Sample No. 3X, it can be seen that Sample No. 3X has a higher magnetic flux density in the area enclosed by the white line, compared to Sample No. 0, Sample No. 3Y, and Sample No. 3Z. In FIG. 14, the area enclosed by the white line is the area near the second end core portion 35b of the first side core portion 331. In Sample No. 3X, a large amount of magnetic flux flows through the side core portions 33. In Sample No. 3X, it can be seen that the leakage magnetic flux from the side core portions 33 to the outside is suppressed.

### (Inductance Analysis)

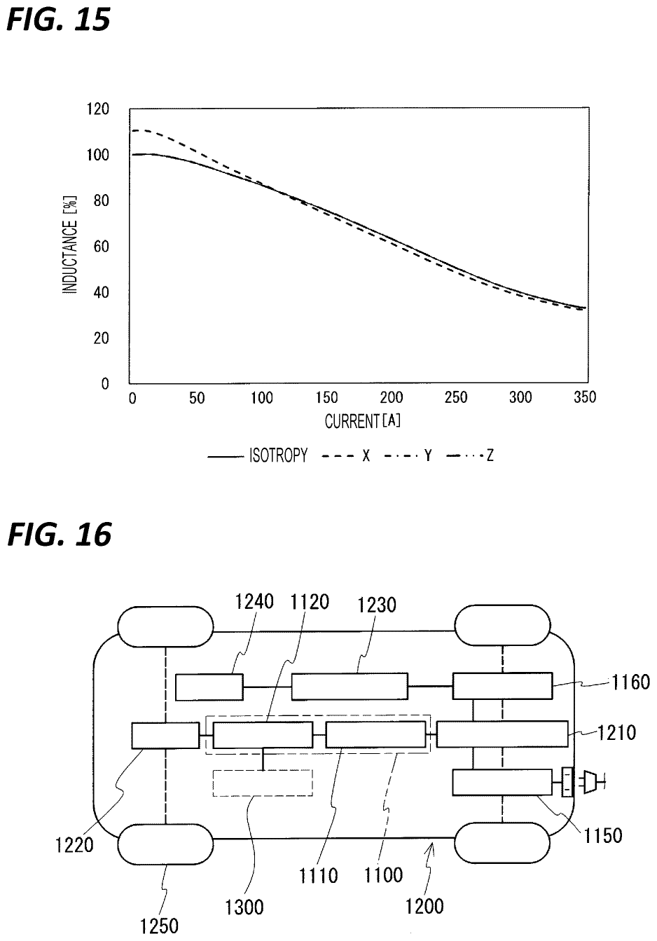

FIG. 15 shows the inductance of each sample. The inductances in FIG. 15 are shown as ratios relative to the inductance (100%) of Sample No. 0 at a current of 0 A. The solid line indicates the inductance of Sample No. 0, which is isotropic. The dashed line indicates the inductance of Sample No. 3X, which is anisotropic in the X-axis direction. The one-dot chain line indicates the inductance of Sample No. 3Y, which is anisotropic in the Y-axis direction. The two-dot chain line indicates the inductance of Sample No. 3Z, which is anisotropic in the Z-axis direction.

As shown in FIG. 15, in the low current range from 0 A to 100 A, the inductance of Sample No. 3X is higher than the inductance of Sample No. 0. The inductance of Sample No. 3X at a current of 0 A is improved by 10% or more compared to the inductance of Sample No. 0. The inductances of Sample No. 3Y and Sample No. 3Z are substantially the same as the inductance of Sample No. 0. These results indicate that inductance increases more when the side core portions 33 are anisotropic in the X-axis direction. The inductance is considered to have slightly increased due to the high relative permeability of the side core portions 33 in the X-axis direction, which results in a relatively large variation in the magnetic flux linked with the coil 2.

### LIST OF REFERENCE NUMERALS

1 Reactor
2 Coil
   20 Winding portion, 2a First end, 2b Second end
3 Magnetic core
   3a First core piece, 3b Second core piece
   31 Middle core portion
   31a First middle core portion, 31b Second middle core portion, 31g Gap portion
   33 Side core portion
   331 First side core portion, 332 Second side core portion
   35 End core portion
   35a First end core portion, 35b Second end core portion
   50 Core portion
   51 First core portion, 52 Second core portion
7 Mold
   71 First mold, 72 Second mold, 73 Third mold, 74 Fourth mold
   81 First magnetic field device
   82 Second magnetic field device, 82c Coil, 82m Iron core
9 Composite material
   90 Resin, 91 Soft magnetic powder
   92 Particle, 92c Round particle, 92f Elongated particle
1100 Power conversion device
   1110 Converter, 1111 Switching element, 1112 Drive circuit
   1115 Reactor, 1120 Inverter
   1150 Power supply converter, 1160 Auxiliary power supply converter
1200 Vehicle
   1210 Main battery, 1220 Motor, 1230 Sub battery
   1240 Auxiliary device, 1250 Wheel
1300 Engine
A Major axis, Da Length of major axis
B Minor axis, Db Length of minor axis
P1, P2 Parallel line
α Inclination
E, S Direction
L Length, W Width, H Height

1. A reactor comprising a coil and a magnetic core,
wherein the magnetic core includes a plurality of core pieces including a first core piece,
the first core piece is constituted by a molded body of a composite material in which soft magnetic powder is dispersed in resin,
the first core piece is E-shaped and includes an end core portion, a middle core portion, and two side core portions,
the end core portion extends in a direction orthogonal to a direction in which the middle core portion and the side core portions extend,
the end core portion is disposed so as to face an end surface of the coil and extend in a direction orthogonal to the axis of the coil,
the middle core portion and the side core portions each extend from the end core portion in a direction along the axis of the coil,
the middle core portion is disposed inside the coil,
the side core portions are disposed in parallel with the middle core portion so as to sandwich the coil,
the soft magnetic powder in the end core portion is oriented in a direction in which the end core portion extends,
the soft magnetic powder in the side core portions is oriented in a direction in which the side core portions extend, and
the soft magnetic powder in the middle core portion is not oriented.

2. The reactor according to claim 1,
wherein the content of the soft magnetic powder in the molded body of the composite material is not less than 20 vol % and not more than 80 vol %, based on 100 vol % of the molded body of the composite material.

3. The reactor according to claim 1,
wherein the soft magnetic power includes elongated particles whose aspect ratio is 1.5 or more, and
the aspect ratio is Da/Db that is an aspect ratio of the length Da of the major axis to the length Db of the minor axis of the elongated particles.

4. The reactor according to claim 3,
wherein the proportion of the elongated particles in the soft magnetic powder is 30% or more based on 100% of the total number of particles in the soft magnetic powder.

5. A converter comprising the reactor according to claim 1.

6. A power conversion device comprising the converter according to claim 5.

7. A method for manufacturing a core piece that is to constitute a portion of a magnetic core, comprising the steps of:
placing, into a mold, a composite material in which unsolidified resin and soft magnetic powder are mixed, and molding the composite material; and
applying a magnetic field when molding the composite material in the step of molding the composite material,
wherein the core piece is E-shaped and includes an end core portion, a middle core portion, and two side core portions,
the end core portion extends in a direction orthogonal to a direction in which the middle core portion and the side core portions extend,
the mold is provided with a magnetic field device that applies the magnetic field,
the magnetic field device includes an iron core and a coil wound around the iron core,
the iron core is C-shaped,
the iron core is disposed so as to form a closed magnetic path between the side core portions and the end core portion, and
in the step of applying the magnetic field, the closed magnetic path is formed when the coil is excited, and a magnetic field is applied to the end core portion in a direction in which the end core portion extends, while a magnetic field is applied to the side core portions in a direction in which the side core portions extend.

8. The method for manufacturing a core piece according to claim 7,
wherein the magnitude of the magnetic field is 1.19×10⁶ A/m or more.

9. The method for manufacturing a core piece according to claim 7,
wherein the mold includes a first mold, a second mold, a third mold, and a fourth mold,
the first mold molds outer surfaces of the side core portions,
the second mold molds an outer surface of the end core portion,
the third mold molds end surfaces of the side core portions,
the fourth mold molds inner surfaces of the side core portions, an inner surface of the end core portion, an outer surface of the middle core portion, and an end surface of the middle core portion,
the third mold is made of a magnetic material, and
the first mold, the second mold, and the fourth mold are made of non-magnetic material.

10. (canceled)

11. (canceled)
